(19) United States
(12) Patent Application Publication
(10) Pub. No.: US 2009/0179145 A1
(43) Pub. Date: Jul. 16, 2009

(54) Dopant Delivery and Detection Systems

(75) Inventors: Graham Crouch, Bushey (GB); Jonathan Marcel Gowers, Berghers Hill (GB)

Correspondence Address: FOLEY AND LARDNER LLP;SUITE 500, 3000 K STREET NW, WASHINGTON, DC, 20007, US

(73) Assignee: Smiths Detection-Watford Limited

(21) Appl. No.: 12/227,701

(22) PCT Filed: Jun. 12, 2007
(86) PCT No.: PCT/GB2007/002160

§ 371 Date: Nov. 25, 2008

(30) Foreign Application Priority Data
Jun. 17, 2006 (GB) 0612047.1

(51) Int. Cl. H01J 49/00; G01K 1/14

(52) U.S. Cl. 250/281; 374/142; 374/E13.001

(57) ABSTRACT

An ion mobility spectrometer (1) or other detection apparatus has an external dopant reservoir (22, 41, 24, 44) connected to it. The reservoir has a stainless steel base (22) with a recess (24), a heater (28) and a temperature sensor (32). The heater (28) and sensor (32) are connected to a feedback temperature control (3) to maintain a constant temperature of liquid dopant (100) in the recess (24). A lid (41) is sealed around the upper surface (23) of the base (22) and supports opposite ends of a length of vapour-permeable tubing (51) that is bent down so that a part of its length is immersed in the dopant. One end of the tubing (51) is connected with the IMS (1) and the other end opens externally so that air can be supplied along the tubing to the IMS and collect dopant vapour passed through the wall of the tubing.

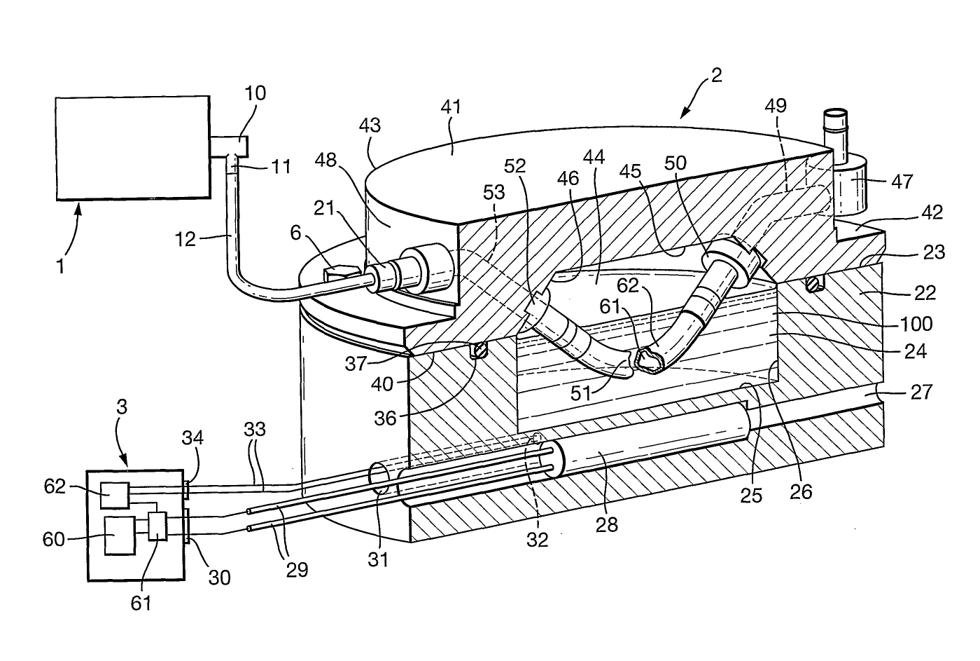

This invention relates to dopant delivery apparatus of the kind including a reservoir containing a supply of dopant chemical.

Field ion mobility detection instruments (IMS) often include provision for chemical doping by which a known, small quantity of a known vapour is added to the pneumatic circuit. The doping vapour produces a known response in the instrument, called the Resident Ion Peak (RIP), which functions as a reference point. Existing dopant sources are usually housed in small cylindrical tubes within the detection instrument. When heated, these sources permeate vapour at a low concentration into the pneumatic circuit of the detector. This relatively crude arrangement means that the dopant concentration varies considerably.

Where an IMS instrument is used to detect Non-Traditional Agents, it is usual to apply additional heat to specific parts of the pneumatic circuit. The side-effect of this increased temperature is to increase the amount of dopant delivered, which, as well as altering dopant concentration, causes the supply of dopant to be exhausted more rapidly. Typically, the existing dopant sources will only sustain continuous doping in these circumstances for a few months.

It is an object of the present invention to provide alternative dopant delivery apparatus and detection systems.

According to one aspect of the present invention there is provided dopant delivery apparatus of the above-specified kind, characterised in that a gas passage extends through the apparatus, that the gas passage has a wall along at least a part of its length exposed to the contents of the reservoir, the wall being permeable to vapour of the dopant, that the gas passage is adapted to be connected at one end to a pneumatic circuit of detection apparatus, and that the apparatus includes a heater for heating the chemical in the reservoir, and a sensor for deriving an indication of the temperature of the chemical in the reservoir.

The dopant chemical is preferably a liquid. The gas passage is preferably provided at least in part by a tube having a vapour-permeable wall, such as of PTFE. A part at least of the length of the tube may be immersed in the chemical. The reservoir preferably includes a base with a recess containing the dopant chemical and a lid sealed with the base and enclosing the recess. The tube is preferably attached with the lid, opposite ends of the tube communicating with respective inlet and outlet passages extending through the lid. The heater may be located in the base below the recess and the temperature sensor may be located in the base below the recess. The heater and temperature sensor are preferably located in respective different bores in the base. The apparatus preferably includes a feedback temperature control arranged to control energisation of the heater in response to the output of the sensor such as to maintain a substantially constant temperature of the dopant chemical. The reservoir may be of stainless steel.

According to another aspect of the present invention there is provided dopant delivery apparatus including a reservoir containing a dopant chemical, characterised in that a gas passage extends through the apparatus, that the gas passage has a wall along at least a part of its length exposed to the contents of the reservoir, the wall being permeable to vapour of the dopant, that the gas passage is arranged to supply dopant vapour to detection apparatus, and that the apparatus includes a temperature control unit arranged to maintain a substantially constant temperature of the chemical in the reservoir.

The dopant delivery apparatus may be separate from and connected with the detection apparatus. The detection apparatus may include an ion mobility spectrometer.

A detection system including dopant delivery apparatus according to the present invention will now be described, by way of example, with reference to the accompanying drawing, which is a perspective cross-sectional view of the apparatus.

The system includes detection apparatus in the form of an ion mobility spectrometer IMS 1, a dopant delivery module 2 externally of the IMS, and a temperature control unit 3. The units are not drawn to scale in the drawing.

The IMS 1 is entirely conventional and will not be described here. It has an inlet 10 at one end for analyte gas or vapour to be detected and a dopant inlet 11 adjacent the analyte inlet, which is connected via tubing 12 to an outlet coupling 21 on the dopant delivery module 2. The dopant could be supplied to the IMS 1 at different locations, as is well known in IMS instruments.

The dopant delivery module 2 is generally cylindrical with a circular shape when viewed from above. The lower part of the module 2 is formed by a base body 22 of stainless steel or other suitable material which is resistant to the chemical dopant being used. The upper face 23 of the base body 22 has a centrally-located, circular well or recess 24 extending down to about half the height of the base. The well 24 has a flat floor 25 and an annular wall 26, both uninterrupted by any apertures or openings. The well 24 contains a quantity 100 of dopant chemical, such as ammonia or acetone, in a liquid or solid form, such as a powder. A bore 27 extends through the body 22 across its diameter, just below the floor 25 of the well 24. The bore 27 contains an electrical resistance heating element 28 positioned centrally of the well 24. Wires 29 from the heating element 28 extend out of one end of the bore 27 and connect with the outlet 30 of the temperature control unit 3. A second bore 31 extends parallel to and spaced a small distance from the heater bore 27. The second bore 31 contains an electrical temperature sensor 32 in the form of a platinum resistance thermometer or the like. The temperature sensor 32 is positioned to provide an indication of the temperature of the contents of the well 24 and is preferably spaced a distance from the heater 28 so that it is not directly warmed by this. Wires 33 from the sensor 32 extend to the input 34 of the temperature control unit 3.

A groove 36 extends around the opening of the well 24 on the upper face 23 and receives a resilient O-ring seal 37 the dimensions of which are such that it is compressed between the upper face of the base body 22 and the lower face 40 of a lid 41. The lid 41 is also of stainless steel and has a circular top-hat shape with a peripheral flange 42 and a central taller portion 43. The diameter of the lid 41 is the same as that of the base body 22 and it is retained on the base body by means of bolts 6 extending through the flange. 42 into tapped holes in the upper face 23 of the base body. Other arrangements, such as clamps or the like could be used to retain the two parts with each other. The lower face 40 of the lid has a central circular recess 44 of the same diameter as the well 24 and of truncated cone shape, with a flat central roof 45 and a tapering side wall 46. The recess 44 and the well 24 in the base 22 together provide an enclosed reservoir for the chemical dopant liquid 100.

The dopant delivery module 2 has a gas passage extending through it, one end being provided by an external inlet coupling 47 on the lid 41, secured to the vertical, external wall 48 of the central portion 43. This connects with a machined bore 49 extending at an angle downwardly through the thickness of the lid 41 from the external wall 48 to the tapering internal wall 46. The internal end of the bore 49 opens into an internal coupling 50 mounted on the tapering wall 46 and this in turn opens into the bore 61 at the inlet end of a permeation tube 51. The permeation tube 51 has a wall 62 of a material that is permeable to vapour of the chemical dopant 100 being used. For example, if the dopant 100 were ammonia or acetone the tube could be made of PTFE. The opposite, outlet end of the permeation tube 51 connects with a second internal coupling 52 mounted diametrically opposite the first coupling 50 on the tapering wall 46. The permeation tube 51 is bent downwardly in a curve so that its central region is lower than its two ends. Depending on the level of the dopant 100 in the well 24, all, or only a part of, the tube 51 will be partially immersed in the chemical dopant but any part not immersed in the dopant will be exposed to vapour above the dopant surface. The second internal coupling 52 similarly connects with a bore 53 machined through the lid 41 at an angle upwardly from the internal coupling to the external outlet coupling 21 mounted on the vertical wall 48. The external coupling 21 connects with the tubing 12 which is of a conventional, impervious material.

The temperature control unit 3 has a power supply 60 connected to the outlet 30 via a switching unit 61. A processor 62 is connected with the inlet 34 and controls switching of the switching unit 61. Switching of the unit 61 is controlled to maintain the temperature of the chemical dopant 100 in the well 24 at the desired temperature. The feedback from the temperature sensor 32 enables this temperature to be maintained within acceptable tolerance limits, typically to within about ±1° C.

In operation, external air flows from the inlet coupling 47, along the permeation tube 51 and to the inlet of the IMS 1. The air may be caused to flow along this path by means of a fan or pump within the IMS, or by a fan or pump (not shown) at the inlet of the dopant delivery module 2. During its passage through the permeation tube 51, air picks up dopant vapour that has permeated through the wall of the tube. Because the temperature of the dopant is controlled, the mass flow rate of dopant delivery to the IMS 1 can be maintained substantially constant.

The dopant delivery module of the present invention can hold a relatively large volume of dopant compared with conventional dopant units within an IMS instrument. To prevent excessive dopant consumption, the dopant source operates at a higher temperature than that produced within the IMS pneumatic circuit and utilises a feedback circuit to achieve accurate temperature control. This prevents excessive dopant consumption caused by elevated temperatures. Modules of the present kind would be capable of supplying dopant vapour to an IMS continuously for a period of about 5 years. Because the housing of the delivery module is made of a metal, this has a relatively high heat capacity so that any interruption to power supply takes longer to produce a significant fall in temperature of the dopant.

A single dopant module could be connected to several different detectors to reduce space, weight and expense.

It will be appreciated that the invention is not confined to use with IMS apparatus but could be used with any detector apparatus where doping is required.

Instead of the dopant delivery module being connected to the IMS, as described above, at a connection separate from the gas analyte inlet, it would be possible for the gas analyte inlet to be provided through the gas passage through the dopant delivery module, so that the gas analyte collects dopant vapour before admittance to the IMS or other detector. The dopant delivery module could be connected in a recirculating system where its inlet is connected to the outlet of the pneumatic circuit of the detector.

The reservoir within the dopant delivery module could be filled without removing the lid if a chemical inlet were provided in the lid or base. This could enable chemical dopant to be filled to a level above the join between the base and the lid and thereby increase the volume of dopant. It is not essential that the passage in the dopant reservoir be of tubular form. It could, for example be provided by a passage with a permeable wall extending on a surface of the reservoir.

1. Dopant delivery apparatus including a reservoir containing a supply of dopant chemical, wherein a gas passage extends through the apparatus, that the gas passage has a wall along at least a part of its length exposed to the contents of the reservoir, the wall being permeable to vapour of the dopant, that the gas passage is adapted to be connected at one end to a pneumatic circuit of detection apparatus, and that the apparatus includes a heater for heating the chemical in the reservoir, and a sensor for deriving an indication of the temperature of the chemical in the reservoir.

2. Dopant delivery apparatus according to claim 1, wherein the dopant chemical is a liquid (100).

3. Dopant delivery apparatus according to claim 1, wherein the gas passage is provided at least in part by a tube having a vapour-permeable wall.

4. Dopant delivery apparatus according to claim 3, wherein the wall of the tube is of PTFE.

5. Dopant delivery apparatus according to claim 3, wherein a part at least of the length of the tube is immersed in the chemical.

6. Dopant delivery apparatus according to claim 1, wherein the reservoir includes a base with a recess containing the dopant chemical and a lid sealed with the base and enclosing the recess.

7. Dopant delivery apparatus according to claim 6, wherein the tube is attached with the lid, and that opposite ends of the tube communicate with respective inlet and outlet passages extending through the lid.

8. Dopant delivery apparatus according to claim 6, wherein the heater is located in the base below the recess.

9. Dopant delivery apparatus according to claim 6, wherein the temperature sensor is located in the base below the recess.

10. Dopant delivery apparatus according to claim 9, wherein the heater and temperature sensor are located in respective different bores in the base.

11. Dopant delivery apparatus according to claim 1, wherein the apparatus includes a feedback temperature control arranged to control energisation of the heater in response to the output of the sensor such as to maintain a substantially constant temperature of the dopant chemical.

12. Dopant delivery apparatus according to claim 1, wherein the reservoir is of stainless steel.

13. Dopant delivery apparatus including a reservoir containing a dopant chemical, wherein a gas passage extends through the apparatus, that the gas passage has a wall along at least a part of its length exposed to the contents of the reservoir, the wall being permeable to vapour of the dopant, that the gas passage is arranged to supply dopant vapour to detection apparatus, and that the apparatus includes a temperature control unit arranged to maintain a substantially constant temperature of the chemical in the reservoir.

14. A detection system including detection apparatus and dopant delivery apparatus according to claim 1, wherein the dopant delivery apparatus is separate from and connected with the detection apparatus.

15. A detection system according to claim 14, wherein the detection apparatus includes an ion mobility spectrometer.
